(19) United States
(12) Patent Application Publication
(10) Pub. No.: US 2004/0179853 A1
(43) Pub. Date: Sep. 16, 2004

(54) Active assembly apparatus of planar lightguide circuit

(76) Inventor: Wien-Haurn Kuu, Kaohsiung Hsien (TW)

Correspondence Address: WILLIAM B. PATTERSON, MOSER, PATTERSON & SHERIDAN, L.L.P., Suite 1500, 3040 Post Oak Blvd., Houston, TX, 77056, US

(21) Appl. No.: 10/621,211

(22) Filed: Jul. 16, 2003

(30) Foreign Application Priority Data
Mar. 11, 2003 (TW) 92105272

(51) Int. Cl. H04B 10/04

(52) U.S. Cl. 398/195

(57) ABSTRACT

An active assembly apparatus of planar lightguide circuit is described. The active assembly apparatus has an optical signal generating and receiving device, a feedback control device, and at least one displacement device made of piezoelectric substrate. The optical signal generating and receiving device connects to a transmitting core in a planar lightguide circuit to transmit optical signals to the transmitting core for judging an optical receiving element position and receive optical signals from the transmitting con for judging an optical emitting element position. The feedback control device determines whether the optical receiving element and the optical emitting element are at their respective best positions and, if not, controls the displacement devices to move the optical receiving element and the optical emitting element to their respective best position.

### BACKGROUND OF THE INVENTION

1. Field of the Invention

The present invention relates to an active assembly apparatus for constructing a planar lightguide circuit and especially to an active assembly apparatus with piezoelectric materials and feedback controls for constructing a planar lightguide circuit.

2. Description of the Related Art

Computers have been widely applied in all fields and network technologies have rapidly progressed. Therefore, people can easily access information and provide services by way of networks. Due to the enormous data transmission capacity of optoelectronic communication devices, optoelectronic technology seems a likely candidate for improving transmission quality. Currently, the optoelectronic industry combining the electronics industry and the optics industry is progressing well.

When combined with the semiconductor manufacture processes, optical signals can transmit in a planar lightguide circuit. With wavelength division multiplexer (WDM) technology, a single optical fiber can transmit more laser wavelengths to increase usable bandwidth for transmission signals. For example, if an optical fiber can transmit four laser wavelengths signals at the same time, the usable bandwidth is four times the original. An optical filter receives the laser light and only a predetermined wavelength of the laser light can pass though the optical filter. The others are reflected by the optical filter. Another optical filter is used for distilling another predetermined wavelength of the laser light and reflects the remainder laser light. A plurality of optical filters combine together to form a wavelength division multiplexer. Therefore, all the optical signals are distilled from the laser light. A dense wavelength division multiplexer (DWDM) with a wavelength step of about 1.6 to 3.2 nanometer (nm) is popularly used in WDM application technology. With DWDM technology, an optical fiber can transmit more optical signals with a higher total transmission rate so as to improve the transmission rate bottleneck in a network.

The planar lightguide circuit utilizes an optical transmitter to transform electronic signals into optical signals and transmit the same to an optical fiber. The light source of the transmitter for optical fiber communication is mainly a light emitting diode (LED) or a laser diode. Since the laser diode has the advantages of high output power, fast transmission speed, small emission angle (i.e. a higher efficiency for coupling light source into an optical fiber), and narrower frequency spectrum (smaller dispersion), the laser diode is suitable for use in mid- or long-range transmission. While the LED has the advantages of low cost and simpler utilization (simpler driving and compensation circuits), an LED is suitable for use in short-range transmission. In particular, the laser diode, or semiconductor laser, has the advantages of small size, low power consumption, quick response, good collision resistance, long operation life, and high efficiency, so that the laser diode is very widely applied in optoelectronic products.

An optical receiver converts an optical signal to an electronic signal, of which the most critical component is a detector. The major purpose of the detector is to generate enough energy by radiating light on a photo diode to excite pairs of electrons and holes so as to generate a current signal.

In an optical transmitter module, a transmitting device, such as a laser diode or a light emitting diode, is disposed at the edge of the lightguide element. Therefore, the alignment between the lightguide element and the transmitting device is very important for correctly transmitting the optical signals into the lightguide element. Otherwise, some of the optical signals will be transmitted into a non-transmitting medium, such as a cladding layer, so as to reduce the optical signal strength.

Accordingly, the optoelectronic component assembly process needs very precise dimension control. Even a little bias thereof will cause signal loss and degrade the optical communication quality.

The traditional assembly apparatus uses the infrared rays to penetrate the mechanical alignment mark on the substrate 210 and the aligned device 240. Accordingly, the infrared rays go through the first mark 230 on the substrate 210, then continue through the second mark 250 on the aligned device 240, and finally reach the infrared receiver 300. The infrared receiver 300 transmits the receiver optical signals to a controller 400 to determine whether the aligned device 240 is aimed at the substrate 210 or not. If the aligned device 240 is not aimed at the substrate 210, the relative position of the aligned device 240 and the substrate 210 is adjusted to fit an alignment tolerance so that the transmitting core 220 can aim at the aligned device.

The traditional assembly apparatus utilizes the mechanical marks to aim the optical transmitter or receiver at the transmitting core. The assembly apparatus is a passive assembly apparatus. The accuracy of the assembly apparatus is established on the mechanical accuracy. But the mechanical accuracy cannot guarantee the accuracy of the optical signals transmission. Even full exactitude of mechanical accuracy in the mechanical dimension requirement may still result in insufficient optical signals transmission accuracy. That is, the practical optical signal transmission may be still fail to meet specifications when the planar lightguide circuit is assembled by a traditional assembly apparatus. Therefore, there is a need to improve the assembly process of the planar lightguide circuit so that the assembly failure rate and the optical signal transmission loss can be reduced and the quality thereof can be improved.

### SUMMARY OF THE INVENTION

It is an object of the present invention to provide an active assembly apparatus of a planar lightguide circuit to mount optical transceiver elements in the planar lightguide circuit so that the optical transceiver module can fulfill the optical signal transmission accuracy requirement.

It is another object of the present invention to utilize a feedback control to improve the assembly accuracy of the planar lightguide circuit so as to enhance the optical signal transmission quality.

It is further object of the present invention to utilize a piezoelectric substrate to mount the optical transceiver elements of the planar lightguide circuit correctly in the best transmitting and receiving positions.

To accomplish the above objectives, the present invention provides an active assembly apparatus of a planar lightguide circuit for aiming an optical transmitter and an optical receiver at a transmitting core of a planar lightguide circuit. The active assembly apparatus includes an optical receiving and transmitting device, a feedback control device, a first displacement device, and a second displacement device. The optical receiving and transmitting device couples with an end of the transmitting core to transmit first optical signals to the optical receiver by way of the transmitting core and receive second optical signals from the optical transmitter by way of the transmitting core.

The feedback control device determines whether the optical transmitter and the optical receiver are disposed at respective optimum positions according to the optical signals received by the optical receiving and transmitting device and the optical receiver, respectively.

The feedback control device further utilizes the first displacement device made of a piezoelectric substrate to adjust the optical transmitter position until the optical transmitter reaches the optimum transmitting position where the optical receiving and transmitting device can receive the second optical signals with maximum strength. The feedback control device further utilizes the second displacement device made of a piezoelectric substrate to adjust the optical receiver position until the optical receiver reaches the optimum receiving position where the optical receiver can receive the first optical signals with maximum strength.

The optical transmitter is a light emitting diode (LED) or a laser diode. The optical receiver comprises a photo diode. The piezoelectric substrate includes quartz, a piezoelectric ceramic, or a piezoelectric polymer.

The planar lightguide circuit further includes a wavelength division multiplexer (WDM) filter to distill the first optical signals and reflect the second optical signals.

Another aspect of the present invention is an active assembly apparatus of planar lightguide circuit for aiming an optical transmitter at a transmitting core in a planar lightguide circuit. A further aspect of the present invention is an active assembly apparatus of a planar lightguide circuit for aiming an optical receiver at a transmitting core in a planar lightguide circuit.

Hence, the active assembly apparatus of planar lightguide circuit according to the present invention eliminates the transmission signal loss and communication quality downgrade induced by the assembly error. The active assembly apparatus according to the present invention effectively enhances the assembly accuracy of the planar lightguide circuit and upgrades the communication quality.

### BRIEF DESCRIPTION OF THE DRAWINGS

The foregoing aspects and many of the attendant advantages of this invention are more readily appreciated as the same becomes better understood by reference to the following detailed description, when taken in conjunction with the accompanying drawings, wherein:

FIG. 1 is a schematic view of a traditional assembly apparatus for constructing a planar lightguide circuit;

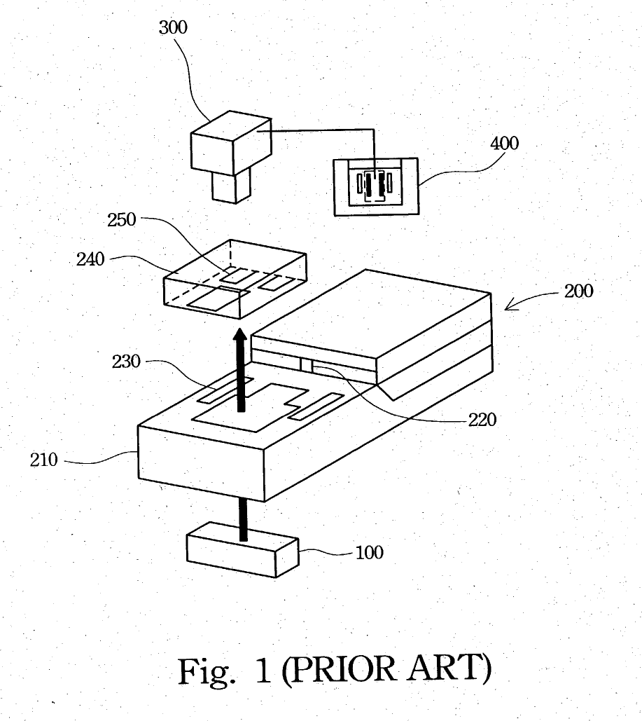

FIG. 2 is a schematic view of a planar lightguide circuit with transceiver function; and

FIG. 3 is a schematic view of the active assembly apparatus of a planar lightguide circuit according to the present invention.

### DETAILED DESCRIPTION OF THE PREFERRED EMBODIMENT

The following description is of the best presently contemplated mode of carrying out the present invention. This description is not to be taken in a limiting sense but is made merely for the purpose of describing the general principles of the invention. The scope of the invention should be determined by referencing the appended claims.

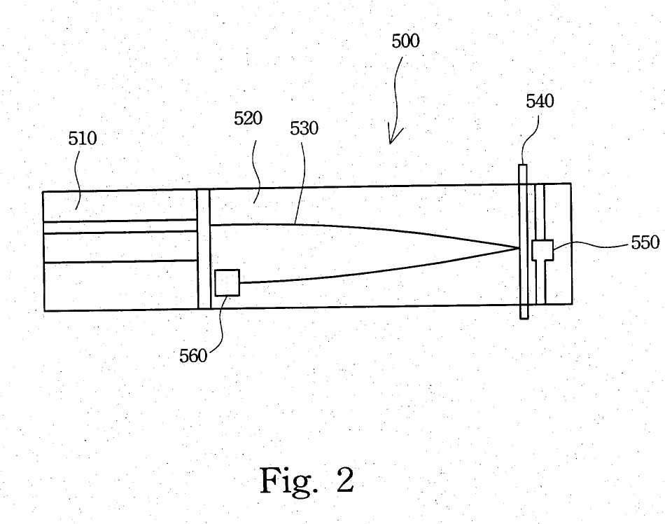

FIG. 2 is a schematic view of a planar lightguide circuit with transceiver function. The planar lightguide circuit 500 includes a V-notch 510 on the left side, a transmitting core 530, a cladding layer 520, a WDM filter 540, a laser diode 560, and a photo diode 550. The laser diode 560 and the photo diode 550 have to be aimed at the transmitting core 530. If the laser diode 560 and the photo diode 550 are not aimed at the transmitting core 530 correctly, signal loss is induced when optical signals are transmitting therein so that the communication quality is reduced.

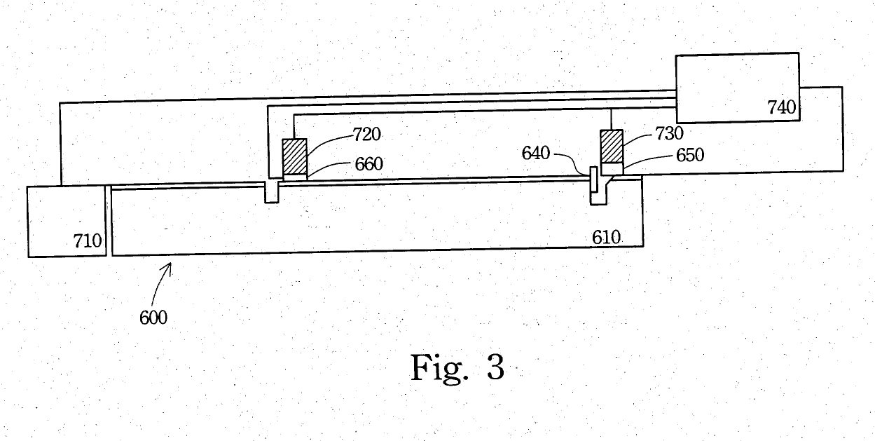

FIG. 3 is a schematic view of the active assembly apparatus of a planar lightguide circuit according to the present invention. The active assembly apparatus 600 of the planar lightguide circuit according to the present invention includes an optical signal generating and receiving device 710, a first displacement device 720, a second displacement device 730, and a control device 740. The first displacement device 720 is utilized to adjust a position of a laser diode 660, and the second displacement device 730 is utilized to adjust a position of a photo diode 650. Both the first displacement device 720 and the second displacement device 730 are made of piezoelectric materials. The piezoelectric substrate provides a mechanical deformation when the piezoelectric substrate is under an electric field. Therefore, a practical deformation of the piezoelectric substrate can be performed by way of an input electrical signal control, such as an input voltage control. Hence, the first displacement device 720 and the second displacement device 730 can utilize voltage signal control to perform the exact displacement thereof.

When the active assembly apparatus aims the photo diode 650 at a transmitting core (referring to the transmitting core 530 of FIG. 2), the optical signal generating and receiving device 710 according to the present invention generates optical signals for adjusting the photo diode 650 to a best position to receive the optical signals. The optical signals pass through the transmitting core, distilled by the WDM filter 640, and arrive the photo diode 650. The photo diode 650 receives the optical signals and transmits corresponding electrical signals to the control device 740. The control device 740 determines whether the position of the photo diode 650 is at a best position or not. If not, the control device 740 issues a requiring voltage signal to the second displacement device 730 to move the photo diode 650 a required displacement. Then, the optical signal generating and receiving device 710 sends optical signals again and the control device 740 determines whether the position of the photo diode 650 is at the best position according to the resend optical signal. The adjusting process repeats until the photo diode 650 reaches the best position for receiving the optical signals. After the photo diode 650 reaches the best position, the photo diode 650 is fixed on a substrate 610 of the planar lightguide circuit 600.

Because the active assembly apparatus according to the present invention directly receives the optical signals with the photo diode 650 to determine whether the position is in the best position for receiving the optical signals, the photo diode 650 is already in the best position when the photo diode 650 is fixed on the substrate 610. The present invention utilizes the piezoelectric substrate to fine tune the photo diode 530 position relative to the transmitting core 530 and the feedback control to reach an optimum optical signal receiving position of the photo diode 650.

The active assembly apparatus of planar lightguide circuit according to the present invention further aims a laser diode 660 at the transmitting core. The assembly process of the laser diode 660 starts from the control device 740 issuing electric signals to the laser diode 660. The laser diode 660 transforms the electric signals into optical signals and then transmits the optical signals to the transmitting core. The optical signals then reflect on the WDM filter 640 and transmit to the optical signal generating and receiving device 710. The optical signal generating and receiving device 710 catches the optical signals, transforms the same into electric signals, and then transmits these electric signals to the control device 740. The control device 740 determines whether or not the laser diode 660 is in a best transmitting position according to these received electric signals. If the laser diode 660 is not in the best transmitting position, the control device 740 issues a requirement voltage signals to the first displacement device to generate a requirement displacement for moving the laser diode 660. The laser diode 660 resends optical signals to the transmitting core and the control device 740 determines whether the laser diode 660 is in the best transmitting position or not. The previously adjusting feedback process is repeated until the laser diode 660 reaches an optimum position on the substrate 610. Then, the laser diode 660 is fixed on the substrate 610 to construct the planar lightguide circuit 600. The displacement device is made of a piezoelectric substrate, such as a quartz, a piezoelectric ceramic or a piezoelectric polymer. The present invention is not limited by the previously exemplary material; any material having piezoelectric behavior is suitable for making the displacement device.

The present invention utilizes the piezoelectric substrate to adjust the optical transmitting device, such as the laser diode, and the optical receiving device, such as the photo diode, to respective optimum positions. Therefore, the optical transmitting device and receiving device in the planar lightguide circuit assembled by the active assembly apparatus of the present invention can be guaranteed to be in the best respective position to have optimum optical signal strength. Hence, the present invention effectively reduces the signal loss and enhances the signal quality.

As is understood by a person skilled in the art, the foregoing preferred embodiments of the present invention are illustrative of the present invention rather than limiting of the present invention. It is intended that various modifications and similar arrangements be included within the spirit and scope of the appended claims, the scope of which should be accorded the broadest interpretation so as to encompass all such modifications and similar structures.

1. An active assembly apparatus of a planar lightguide circuit for aiming an optical transmitter at a transmitting core of a planar lightguide circuit, the active assembly apparatus comprising:
an optical receiving device coupling with an end of the transmitting core to receive optical signals from the transmitting core;
a feedback control device coupling with the optical receiving device and the optical transmitter, the feedback control device controlling the optical transmitter to transmit the optical signals to the optical transmitting core; and
a displacement device coupling with the feedback control device and the optical transmitter, the optical transmitter moving to a position by way of the displacement device according to a output voltage from the feedback control device, wherein the displacement device is made of a piezoelectric substrate and the optical receiving device receives the optical signals with maximum strength at the position.

2. The active assembly apparatus of claim 1, wherein the optical transmitter comprises a light emitting diode (LED).

3. The active assembly apparatus of claim 1, wherein the optical transmitter comprises a laser diode.

4. The active assembly apparatus of claim 1, wherein the piezoelectric substrate comprises quartz.

5. The active assembly apparatus of claim 1, wherein the piezoelectric substrate comprises a piezoelectric ceramic.

6. The active assembly apparatus of claim 1, wherein the piezoelectric substrate comprises a piezoelectric polymer.

7. The active assembly apparatus of claim 1, wherein the planar lightguide circuit further comprises a wavelength division multiplexer (WDM) filter to reflect the optical signals.

8. An active assembly apparatus of planar lightguide circuit for aiming an optical transmitter and an optical receiver at a transmitting core of a planar lightguide circuit, the active assembly apparatus comprising:
an optical receiving and transmitting device coupling with an end of the transmitting core to transmit first optical signals to the transmitting core and receive second optical signals from the transmitting core;
a feedback control device coupling with the optical receiving and transmitting device;
a first displacement device coupling with the feedback control device and the optical transmitter, the first displacement device moving the optical transmitter to a transmitting position according to a first moving request from the feedback control device, wherein the first displacement device is made of a first piezoelectric substrate; and
a second displacement device coupling with the feedback control device and the optical receiver, the second displacement device moving the optical receiver to a receiving position according to a second moving request from the feedback control device, wherein the second displacement device is made of a second piezoelectric substrate, while the active assembly apparatus performs a process for aiming the optical receiver at the transmitting core, the feedback control device controlling the optical receiving and transmitting device transmitting the first optical signals to the transmitting core, and while the active assembly apparatus performs a process for aiming the optical transmitter at the transmitting core, the feedback control device controlling the optical transmitter transmitting the second optical signals to the transmitting core.

9. The active assembly apparatus of claim 8, wherein the first displacement adjusts the optical transmitter to the transmitting position where the optical receiving and transmitting device receives the second optical signals with a maximum strength.

10. The active assembly apparatus of claim 8, wherein the second displacement adjusts the optical receiver to the receiving position where the optical receiver receives the first optical signals with a maximum strength.

11. The active assembly apparatus of claim 8, wherein the optical transmitter comprises a light emitting diode (LED).

12. The active assembly apparatus of claim 8, wherein the optical transmitter comprises a laser diode.

13. The active assembly apparatus of claim 8, wherein the optical receiver comprises a photo diode.

14. The active assembly apparatus of claim 8, wherein the first piezoelectric substrate comprises quartz.

15. The active assembly apparatus of claim 8, wherein the first piezoelectric substrate comprises a piezoelectric ceramic.

16. The active assembly apparatus of claim 8, wherein the first piezoelectric substrate comprises a piezoelectric polymer.

17. The active assembly apparatus of claim 8, wherein the second piezoelectric substrate comprises quartz.

18. The active assembly apparatus of claim 8, wherein the second piezoelectric substrate comprises a piezoelectric ceramic.

19. The active assembly apparatus of claim 8, wherein the second piezoelectric substrate comprises a piezoelectric polymer.

20. The active assembly apparatus of claim 8, wherein the planar lightguide circuit further comprises a wavelength division multiplexer (WDM) filter to distill the first optical signals and reflect the second optical signals.
